(19) United States
(12) Patent Application Publication
(10) Pub. No.: US 2006/0015930 A1
(43) Pub. Date: Jan. 19, 2006

(54) Process for removing stale users, accounts and entitlements from a networked computer environment

(76) Inventor: Idan Shoham, Calgary (CA)

Correspondence Address: Idan Shoham, 500, 1401 1st Street SE, Calgary, AB, T2G 2J3, CA

(21) Appl. No.: 10/890,902

(22) Filed: Jul. 15, 2004

(51) Int. Cl. H04L 9/32

(52) U.S. Cl. 726/6

(57) ABSTRACT

A method for collecting, presenting to stake-holders, reviewing and cleansing data about users and their entitlements in a networked computer environment, called access certification, is presented. This method begins with automated prompts sent to stake-holders, such as managers or application owners, asking them to review a list of their subordinates or users. Stake-holders are required to either certify or mark for later deletion each user. Next, stake-holders review the detailed security entitlements of each subordinate or user, again either certifying or flagging for deletion each item. Finally, stake-holders are asked to provide an electronic signature, indicating completion of their review process. To motivate stake-holder completion of the process, and to roll-up results across an organization, stake-holders are prevented from completing the signature step until all subordinate stake-holders have likewise completed. The present invention provides a feasible method for identifying and eliminating user accounts that are either no longer needed by their owners, or belong to owners who are no longer legitimate users of an organization's computer systems. The same method is used to identify and eliminate entitlements assigned to users who no longer need them. Removal of such stale, obsolete or incorrect users, login accounts, user objects, group memberships and security, entitlements is essential in order to reduce the security exposure (attack surface) posed by excessive privileges and unused accounts, and to comply with government and other regulations stipulating effective internal controls, especially over financial data, and computer security best practices.

### CROSS-REFERENCE TO RELATED APPLICATIONS

Not Applicable

### FEDERALLY SPONSERED RESEARCH

Not Applicable

### SEQUENCE LISTING OR PROGRAM

Not Applicable

### BACKGROUND OF THE INVENTION

1. Field of Invention

A method for collecting, presenting to stake-holders, reviewing and cleansing data about users and their entitlements in a networked computer environment, called access certification, is presented.

2. Background of the Invention

The present invention, access certification, relates in general to a method for reviewing and correcting security, entitlements and user profile data in one or more networked computer systems. It generates changes to user, account and entitlement data in a networked computer environment in any, of the forms:
1. “User U no longer has legitimate reason to access the computer systems in question, so should be removed,” or
2. “User U no longer has legitimate reason to access account A on system S,” or
3. “There is no longer a reason to represent user U on system S with object O,” or
4. “User U no longer has legitimate reason to have entitlement E on system S.” or
5. “User U no longer has legitimate reason to have belong to group G on system S.”

These changes to security system databases are useful in order to remove unneeded security privileges, and so limit the security exposure (attack surface) of those systems.

Without this method, in most organizations, tend to accumulate entitlements and access to systems over time, as their responsibilities change. However, users do not normally lose no-longer-required entitlements in a reliable or timely manner. As a result, over time users accumulate security access to systems that are not appropriate to their responsibilities, and consequently these entitlements pose a security risk.

3. Objects and Advantages

The reductions in security access described in [1] are essential in order to reduce the set of security privileges (entitlements) that a malicious legitimate user might abuse, to reduce the harm that a user who makes an honest mistake in the course of using a computer system might cause, to reduce the ability of past members of an organization to abuse no-longer-legitimate access to systems in order to cause harm, and to reduce the set of accounts and entitlements that an intruder can target, possibly without raising any alarms because they belong to no-longer-present users.

In many organizations, obsolete or stale security, privileges are simply not removed at all, or if they are removed it is with an unreliable and slow process. These organizations are at risk because the prior state of the art in removing such privileges was too costly or difficult to implement.

In some organizations, periodic audits are carried out manually by teams of human auditors, in an effort to find and remove obsolete users, accounts and entitlements. Such audits are costly to carry, out, require significant investment of time and effort, and may focus on just one or a few systems, rather than every significant system and type of access in an organization.

In the course of manual audits, auditors may interview one or many managers or systems owners, in an effort to determine what users, accounts and entitlements are still appropriate. Since auditors can only interview one person (e.g., system owner or manager) at a time, this can be a very slow and time-consuming process.

Another pre-existing method for identifying obsolete users and accounts, but in most cases not entitlements, is to examine last login time/date records on each login account. Accounts whose last login time/date is older than some threshold are presumed to be inactive, and likely obsolete. Unfortunately, some systems do not track this data, especially those into which users do not log in themselves. Most systems do not log the last time that an entitlement was used, so this method does not normally apply to entitlements. In the event that an intruder has gained access to an obsolete account, and uses it regularly, that account will appear to be current and in use, and so will not be flagged as obsolete. To summarize, use of last login time/date gives only circumstantial evidence that an account or user profile may be obsolete, and offers no assistance at all for removing stale user entitlements.

A final pre-existing method for identifying obsolete users, accounts and entitlements is policy- and released provisioning. This method starts by defining a set of detailed roles, each of which identifies component accounts and entitlements on individual systems. The set of defined roles must be sufficient to capture the access requirements of all existing users. Next, every user is classified into one or more roles, such that all of their systems access requirements are expressed in terms of their role membership. Finally, the current accounts and entitlements of every user are collected, and compared to the accounts and entitlements predicted by the role model. Any differences between actual and predicted accounts and entitlements cause either direct changes to the user profiles or requests for change authorization by stake-holders (similar to the mechanism described in [23]).

Unfortunately, the policy- and role-based technique described in [9] is impractical in large organizations (e.g., with 10,000 or more users), as it requires the difficult definition of many detailed roles, and both initial and ongoing classification of users into these roles. The sheer volume of role definitions and user classification, combined with the dynamic nature of most organizations (users are hired, fired and moved quickly, sub-organizations are merged or divested, etc.), make effective role definitions and user classification nearly impossible to accomplish in practice.

Overall, prior strategies for finding and removing stale, obsolete or incorrect users, login accounts, user objects, group memberships and security entitlements from computer systems have been ineffective, incomplete, slow, costly or some combination of these.

### SUMMARY

The reduction in users, accounts and entitlements that results from the method described in [1] helps to secure systems by reducing their attack surfaces, and is required in order to implement effective internal controls over systems, such that the set of users and their access to systems is both known and appropriate to business requirements.

Past strategies for finding and removing stale, obsolete or incorrect users, login accounts, user objects, group memberships and security entitlements from computer systems have not worked well, as described in [11]. The method described herein, which includes automated discovery of users, accounts and entitlements, and which leverages the business knowledge of managers in the organization to identify suspicious items (rather than attempting to define an ideal state using roles and policies), resolves the problems experienced by these past strategies. Namely:
1. The method relies only on data that already exists in most organizations—the accounts and entitlements that can be extracted directly from the computer systems in question, and organization chart data that is present in most HR systems, and in any case which can be produced or completed with a reasonable amount of effort.
2. The method does not require that a formal model of user entitlements be defined or maintained—both of which are too difficult to contemplate in real-world large organizations.
3. The method does not require that a users be classified into roles—which data is difficult to collect initially and costly to maintain over time.
4. The method is direct, essentially leveraging organizational knowledge held by managers, rather than circumstantial (e.g., examining last login records).
5. The method can be automated into a massively parallel process, where many managers are engaged simultaneously, and so can be completed quickly. This contrasts with manual audits, which are paper-based or interview-based, and essentially sequential and therefore slow.

### DRAWINGS—FIGURES

FIG. 1 is a schematic illustrating the networked systems that interact in the access certification method for removing stale, obsolete or incorrect users, login accounts, user objects, group memberships and security entitlements. Arrows indicate communication between systems, and the direction of each arrow indicates the direction of the flow of the bulk of the data in that communication.

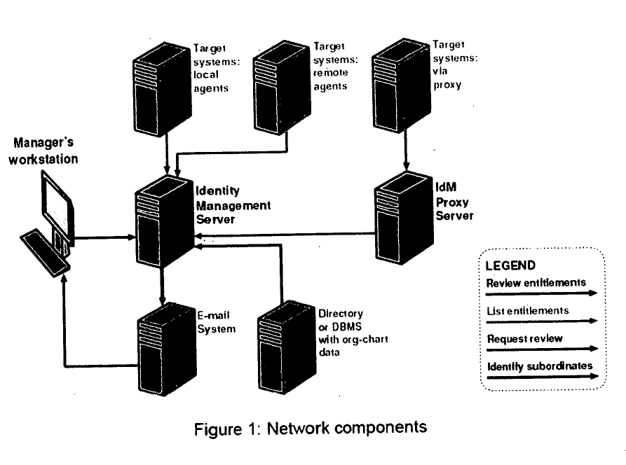

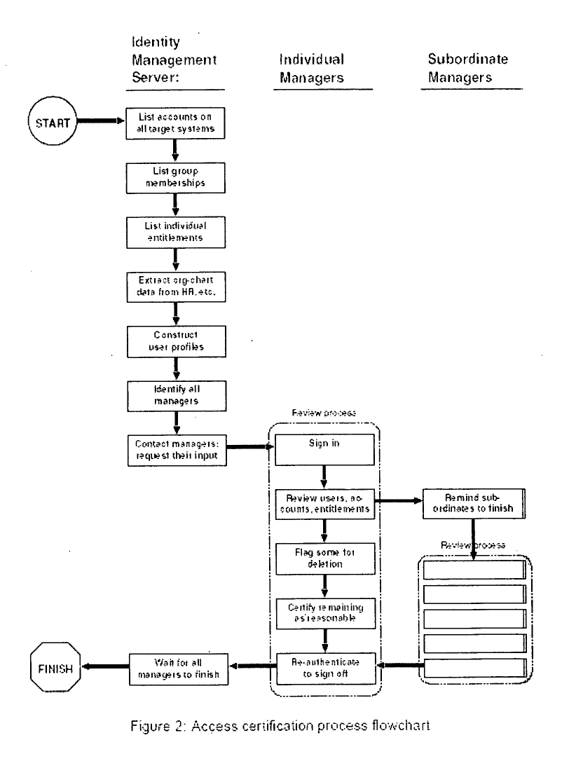

In FIG. 1, one or more systems are tasked to perform the described process. These systems are collectively labeled Identity Management Server.

In FIG. 1, the identity management server periodically collects a list of login IDs from any number of managed systems using one of four mechanisms:
1. Using a managed system's native application programming interface (API), which operates over a network.
2. By communicating with an agent installed on the managed system, and asking that agent to fetch the information using some facility, available locally on that managed system.
3. Using either of the two methods described above, but indirectly, by asking a proxy, server to ask the managed system for the data.
4. (not shown) By having a process execute on the managed system, and send the data through a file transfer mechanism to the identity management server.

The first three methods are also used to validate login ID/password pairs that a user types into to registration user interface on the identity management server.

The identity management server sends requests to review users and entitlements, and subsequent reminders to each manager through an electronic communication system. This is typically e-mail, but may involve other forms of communication (instant messaging, SMS messaging, Windows popup messages and others).

Managers review users and entitlements, by accessing a user interface exposed by the identity management server, and keying in both initial authentication and additional login ID/password pairs. This user interface may take one or more forms, including a web form, a Windows GUI program, e-mail interaction and others.

FIG. 2 is a flow chart diagram illustrating the sequence of steps in the access certification method for removing stale, obsolete or incorrect users, login accounts, user objects, group memberships and security entitlements. The diagram is organized chronologically, with earlier tasks shown above later tasks. Arrows illustrate a sample sequence of events matching those described in [1].

The first three methods are also used to validate login ID/password pairs that a user types into to registration user interface on the identity management server.

The identity management server sends requests to review users and entitlements, and subsequent reminders to each manager through an electronic communication system. This is typically e-mail, but may involve other forms of communication (instant messaging, SMS messaging, Windows popup messages and others).

Managers review users and entitlements, by accessing a user interface exposed by the identity management server, and keying in both initial authentication and additional login ID/password pairs. This user interface may take one or more forms, including a web form, a Windows GUI program, e-mail interaction and others.

FIG. 2 is a flow chart diagram illustrating the sequence of steps in the access certification method for removing stale, obsolete or incorrect users, login accounts, user objects, group memberships and security entitlements. The diagram is organized chronologically, with earlier tasks shown above later tasks. Arrows illustrate a sample sequence of events matching those described in [1].

### DETAILED DESCRIPTION—FIG. 1 NETWORK COMPONENTS AND FIG. 2 ACCESS CERTIFICATION PROCESS FLOWCHART

Definition: Managed System

A managed system may be any computer operating system, database or application where users access some features or data, and where user access must be controlled.

Definition: Target System

Please see [31].

Definition: Platform

A type of managed system. There are many possible types of platforms, including but not limited to:
Network operating systems: Windows NT, Windows 2000, Windows 2003, Novell NetWare, etc.
Directories: Active Directory, NetWare NDS, NIS, NIS+, LDAP, x.500, etc.
Host operating systems: MVS/OS390/zOS, OS400, OpenVMS, Tandem, Unisys, etc.
Groupware and e-mail systems: MS Exchange, Lotus Notes, Novell GroupWise, etc.
Applications: SAP R/3, PeopleSoft, Oracle Applications, etc.
Database servers: Oracle, Sybase, MSSQL, Informix, DB2/UDB, etc.

Definition: User

Users are people in an organization whose access to systems and whose identity information must be managed.

Definition: Manager

A user is deemed to be a manager if one or more other users report to him.

Definition: Subordinate

A user is deemed to be the subordinate of his/her manager. Each manager, by definition, has at least one subordinate.

Definition: Organization chart

An organization chart is some representation, possibly graphical, that captures the manager/subordinate relationships of some or all of the users in an organization. In other words, by reading an organization chart it should be possible to find any given user's manager or managers, and to identify each of that user's subordinates if that user is himself/herself a manager.

Definition: Account

An account is the data used by a system to identify a single user, authenticate a user and control that user's access to resources.

Definition: Login ID

On most systems, accounts are uniquely identified by a short string of characters. This is called the Login ID, user ID or login name.

Definition: Standard Login ID

In some environments a user may have a standard login ID, which is expected to be the same on every system.

Definition: Global ID

A global login ID is an identifier, which uniquely identifies a user in an organization. It may or may not be used as the Login ID on any one system, but is guaranteed to be unique (i.e., no two users may share the same Global ID in the same organization).

Definition: Entitlement

An entitlement is some representation of data on a managed system, which enables a single user to perform some function or access some data on that system.

Definition: Group

A group is a set of data on a single managed system that identifies a collection of users on that system. On many systems, entitlements may be assigned to groups rather than users, as this reduces the ongoing cost of security administration.

Definition: Attribute

An attribute is some characteristic of a user, either associated with that user globally, or specific to that user's account with in a single managed system. For example, login ID, full name or phone number might all be user attributes.

Definition: User Profile

A user profile is the collection of all data available about a user. It contains, at a minimum, a user's global ID in the organization, every login ID of that user on managed systems, every attribute associated with the user either globally or on individual systems, and every group membership of that user. The user profile may also contain a list of the user's managers and subordinates.

Definition: Role

A role is a collection of accounts and entitlements, spanning one or more managed a system, which represents the systems access requirements of a group of users. Roles are defined in identity management systems, and are not, in general, understood by individual managed systems.

Definition: Policy

A policy is a set of rules, typically based on information in a user's profile, which define what one or more roles pertain to that user.

Definition: Group Membership

The inclusion of a particular user, on a particular managed system, in a particular group. This may infer the assignation of the some one or more entitlements, which have been associated with the group in question, to the user in question.

Definition: Authentication

Authentication is a process used by a system to uniquely identify, a user. Most systems authenticate users by asking them to type a secret password. Other forms of authentication include:
Using hardware tokens.
Using a PKI certificate.
Using a smart card.
Providing a biometric sample (finger print, voice print, etc.)
Answering personal questions.

Definition: Electronic Signature

A signature is a process by which a user attests to some statement. Traditional signatures involve writing one's name in some stylized, presumably difficult-to-reproduce fashion. Similarly, electronic signatures typically require the input of some data known only to the user, such as a secret password, and logging that act in a form that is difficult to simulate.

Definition: Access Certification

An access certification is the process by which a manager reviews the users, accounts, user objects, entitlements and group memberships of his/her subordinates, identifies those that do not appear to be reasonable, and signs a statement that indicates that the remaining list is appropriate.

Definition: Agent

An agent is a software component that allows an access management system to create, update or delete accounts on a managed system, or that allows an authentication management system to set or validate passwords or other authenticators on a managed system.

Agents may be installed on the access management or authentication management server itself, on the managed system, or on an intermediate (proxy) server.

Agents installed on the identity management server are sometimes called remote agents, because they use a remote administration software protocol understood by the managed system. Conversely, agents installed on the managed system are sometimes called local agents.

Definition: Connector

Connector is another term for agent—see [84].

Definition: Identity Management Server

Identity management systems normally run on their own hardware, on a dedicated server. This is the identity management server.

Examples are servers used to provide self-service password reset, password synchronization, consolidated user administration, to manage access change authorization workflow, etc.

The invention described here is a process to identify and remove stale, obsolete or incorrect users, login accounts, user objects, group memberships and security entitlements from computer systems. These result from business changes, principally because users change responsibilities or leave the organization.

The process is implemented by a computer program performing the following steps:
1. Periodically constructing an inventory of login IDs by extracting this data from the internal user profile databases of a number of networked computer systems.
2. Periodically constructing an inventory of entitlements by extracting group membership and security attribute data from the internal user profile databases of some or all of the above-mentioned networked computer systems.
3. Constructing a list of users by merging login IDs from one or more systems of record.
4. Identifying managers in the above mentioned list of users, by referring to an electronic representation of an organization chart, to identify users with one or more subordinates.
5. Checking the review status of each manager. At least three status codes are required: unprompted, prompted and completed.
6. Sending electronic notification to unprompted managers, and reminders to prompted managers, asking them to sign into an access certification application and to review the users, accounts and entitlements of their subordinates.
7. Authenticating managers when they sign in by accepting their login ID and password to some system of record, and asking that system to check those values.
8. Displaying to each manager a list of their subordinates, login accounts and other user objects associated with each of their subordinates, and entitlements associated with each login account or user object, and asking each manager to identify suspicious or erroneous users, accounts and entitlements in the list. Conversely, managers may be asked to identify, reasonable users, accounts and entitlements in the list, so that suspicious or erroneous ones can be inferred.
9. Displaying to each manager the review status of each of their subordinate managers, so that each manager will communicate with and cause their subordinate managers to complete the process as well.
10. Prompting each manager with no subordinate managers, upon completion of his/her review, to review the text of a legal agreement validating completion of the review process, and to electronically sign that legal agreement by re-authenticating (as in step 7).
11. Prompting each manager whose subordinate managers have no subordinate managers of their own, and who have completed step 10, upon completion of his/her review, to review the text of a legal agreement validating completion of the review process, and to electronically sign that legal agreement by re-authenticating (as in step 7).
12. Repeating step 11 by traversing the organization chart from bottom to top, until at last all managers except the very top one have completed step 11, and the top manager (e.g., in a private corporation typically the CFO or CEO) can certify the appropriateness of the users, accounts and entitlements of the people who report directly to him, and also can offer some assurance that every other manager in the organization has done likewise.

This process has several advantages over other strategies that have been used in the past in an attempt to achieve the same end result of limiting user access to and entitlements on computer systems to just those that are appropriate to business requirements:
1. This process is feasible to implement. It does not require massive new data such as role definitions or user-to-role classification.
2. This process is feasible to automate, and does not have to be implemented by manual interviews or with massive reports listing current users and entitlements.
3. This process can be executed in parallel, with hundreds or thousands of managers concurrently reviewing the access rights of their subordinates. As a result, this process can be completed in a fairly short period of time.
4. The process is direct, in that it asks managers to indicate what users, accounts and entitlements are incorrect or inappropriate. In contrast, some past processes have inferred inappropriate access through measured inactivity, which is strictly circumstantial evidence, and ma, lead to incorrect results.
5. This process does not require modeling of security privileges, which has proven to be challenging or impossible to implement in large organizations in the past.

I claim:

1. A method for collecting, presenting to stake-holders, reviewing and cleansing data about users and their entitlements in a networked computer environment, called access certification, comprising the steps of:
(a) Periodically constructing an inventor, of login IDs by extracting this data from the internal user profile databases of a number of networked computer systems.
(b) Periodically constructing an inventory of entitlements by extracting group membership and security attribute data from the internal user profile databases of some or all of the abovementioned networked computer systems.
(c) Constructing a list of users by merging login IDs from one or more systems of record.
(d) Identifying managers in the above mentioned list of users, by referring to an electronic representation of an organization chart, to identify users with one or more subordinates.
(e) Checking the review status of each manager. At least three status codes are required: unprompted, prompted and completed.
(f) Sending electronic notification to unprompted managers, and reminders to prompted managers, requesting them to sign into an access certification application and to review the users, accounts and entitlements of their subordinates.
(g) Authenticating managers when they sign in by accepting their login ID and password to some system of record, and requesting that system to check those values.
(h) Displaying to each manager a list of their subordinates, login accounts and other user objects associated with each of their subordinates, and entitlements associated with each login account or user object, and asking each manager to identify suspicious or erroneous users, accounts and entitlements in the list. Conversely, managers may be asked to identify reasonable users, accounts and entitlements in the list, so that suspicious or erroneous ones can be inferred.
(i) Displaying to each manager the review status of each of their subordinate managers, so that each manager will communicate with and cause their subordinate managers to complete the process as well.
(j) Prompting each manager with no subordinate managers, upon completion of his/her review, to review the text of a legal agreement validating completion of the review process, and to electronically sign that legal agreement by re-authenticating (as in step 1g).
(k) Prompting each manager whose subordinate managers have no subordinate managers of their own, and who have completed step 1j, upon completion of his/her review, to review the text of a legal agreement validating completion of the review process, and to electronically sign that legal agreement by re-authenticating (as in step 1g).
(l) Repeating step 1k by traversing the organization chart from bottom to top, until at last all managers except the very top one have completed step 1k, and the top manager (e.g., in a private corporation typically the CFO or CEO) can certify the appropriateness of the users, accounts and entitlements of the people who report directly to him, and also can offer some assurance that every other manager in the organization has done likewise.

2. The method as set forth in claim 1, wherein at step 1a the inventory of login IDs extracted from each system is in the form of a list, where each list entrap consists of a unique system identifier plus a user identifier unique within that system.

3. The method as set forth in claim 1 wherein at step 1a a variety of means may be used to extract the login ID inventory from each system, including:
(a) Use of an application programming interface (API) native to that system,
(b) Installation of a specially constructed agent directly on that system,
(c) Communication between the system executing the process described herein (hereinafter referred to as the identity management server), and the managed system, using an intermediate or proxy server.
(d) Execution of some software or script directly on the managed system, with the resulting list placed in a file, and transferred to the identity management server.

4. The method as set forth in claim 1, wherein at step 1b the inventory of user entitlements and user/group memberships extracted from each system is in the form of a list, where each list entry consists either of a unique system identifier plus a user identifier unique within that system and a group identifier unique within that system, or else a unique system identifier plus a user identifier unique within that system and a code uniquely specifying an entitlement within that system.

5. The method as set forth in claim 1, wherein at step 1b the same variety of means may be used to extract user/group memberships and user entitlements from each system, as those described in step 3.

6. The method as set forth in claim 1, wherein at step 1c each user profile is represented as a globally unique user identifier, a list of attributes that hold either globally or locally to some target system, a list of system identifier/login identifier pairs enumerating every system on which the user in question has an account or a user object, and a list of additional globally unique user identifiers, representing the subordinates who report to the first user in the organization.

7. The method as set forth in claim 1, wherein at step 1c the attributes of each user either contain or may be used to calculate contact information for every user profile. For example, a login ID on a primary network login system may be used to contact a user by opening a web browser during that user's network login sequence. Alternately, an e-mail address can be used to contact a user by sending that user an electronic mail message.

8. The method as set forth in claim 1, wherein at step 1d every user profile is classified as either being a manager or not, depending on whether that user's profile contains the globally unique identifiers of one or more subordinates, or not, respectively.

9. The method as set forth in claim 1, wherein at step 1e every user profile is assigned a status code, or state. Initially, all user profiles are flagged as “unprompted.” As subsequent steps are executed, the status assigned to any given user profile may, be changed to “prompted” or “completed.” Other status codes, such as “late” or “reminded,” may also be used to streamline the use of the method, but are not strictly required.

10. The method as set forth in claim 1, wherein at step 1f notification sent to the user include a reference or link to the program the user must access to proceed to step 1g. This reference may, take manta forms, including that of an embedded uniform resource locator (URL).

11. The method as set forth in claim 1, wherein at step 1f the frequency with which any given user is reminded to complete the process can be limited, so that the process does not become a nuisance to users.

12. The method as set forth in claim 1, wherein at step 1f the total number of requests to complete the process sent to users per iteration of the process is limited, so that the process does not become an undue burden to the electronic communication infrastructure.

13. The method as set forth in claim 1, wherein step 1f is executed at least once, but may be repeated numerous times—e.g., once per day or even more often, over the course of weeks or months.

14. The method as set forth in claim 1, wherein at step 1f notification sent to the user that registration is requested may take the form of any electronic communication, including electronic mail.

15. The method as set forth in claim 1, wherein at step 1f some subset (and possibly all) of the users whose profiles have a status code of “unprompted” are contacted by the software executing the method, and asked (prompted) to respond by authenticating to the system (as described in step 1g) and review the identities and entitlements of their subordinates (as described in step 1h).

16. The method as set forth in claim 1, wherein at step 1f, after initial contact with each user, that user's status code is changed from “unprompted” to “prompted.”

17. The method as set forth in claim 1, wherein at step 1f, additional contact may be made with some users, depending on the specific implementation and use of other status codes. For example, users who have been previously contacted (and so whose status code is “prompted”) but who have not responded in a timely fashion, may be contacted again, and have their status changed from “prompted” to “reminded.” Similarly, one or more managers of users whose status code is already set to “reminded” or other people, whose identity depends on implementation details, may be contacted in lieu of an unresponsive user, and a status code of “escalated to another user's login ID” may be assigned in the unresponsive user's profile.

18. The method as set forth in claim 1, wherein at step 1g the user may be authenticated, proving his/her identity, using a number of alternative means, including:
(a) Typing his/her own network login ID and password.
(b) Typing his/her own application login ID and password.
(c) Using a cryptographic certificate, stored in hardware (e.g., a smart card) or software (e.g., on a computer workstation, perhaps in the operating system or web browser)
(d) Using a hardware authentication tokens (e.g., one that uses a challenge/response algorithm or one that displays a new pseudo-random number every few seconds or minutes).
(e) Providing a biometric sample (finger print, iris scan, voice print, etc.)
(f) Answering one or more personal questions.
(g) Any combination of the above authentication factors.

19. The method as set forth in claim 1, wherein at steps 1h and 1j the computer program executing the method displays to the user (who authenticated in step 1g) a list of that user's subordinates, a list of each subordinate's login accounts and user objects, and a list of entitlements and group memberships associated on computer systems with each of those login accounts and entitlements.

20. The method as set forth in claim 1, wherein at steps 1h and 1i the computer program executing the method indicates to the user (who authenticated in step 1g) which of his/her subordinates are themselves managers (by virtue of having their own subordinates), and the status of each of those managers (e.g., unprompted, prompted, reminded) and possibly other status codes (e.g., “reminded,” “started but not completed,” “escalated,” etc.).

21. The method as set forth in claim 1, wherein at step 1h each authenticated manager is required to indicate which of the users, accounts or objects, and group memberships or entitlements appear to be obsolete—the user in question is no longer a valid user of any system, or the account in question is no longer relevant to the user's responsibilities, or the entitlement in question is no longer relevant to the user's responsibilities.

22. The method as set forth in claim 1, wherein at step 1h, conversely to the above, each authenticated manager maw indicate which of the users, accounts or entitlements are still appropriate, rather than identifying those that appear to be no longer correct.

23. The method as set forth in claim 1 wherein at step 1h, every user, account or entitlement that has been flagged as inappropriate, obsolete or otherwise incorrect by a manager may either be directly removed from the computer systems in question, or else a review/approvals workflow process may, be initiated, whereby appropriate stakeholders in the organization (who may themselves be higher level managers, system openers, security administrators, etc.) must first review the indicated change and approve it before it is finally applied to the computer systems in question.

24. The method as set forth in claim 1, wherein at steps 1h and 1i each manager is expected or may be required to follow up with his/her subordinate managers, to expedite their completion of the process.

25. The method as set forth in claim 1, wherein at step 1h each manager may be unable to complete his/her own review until all of his/her subordinate managers have completed their own reviews, of their own subordinates, and in turn their subordinate managers have completed their own reviews, etc. In other words, a manager may be unable to complete his/her own review of users, accounts and entitlements until all subordinate managers, regardless of how many steps down the organization chart they are from him, have also completed their own reviews.

26. The method as set forth in claim 1, wherein at step 1j a manager with no subordinates can complete the review by reading legally binding text reaffirming completion of his/her review, and providing an electronic signature, such as a validated password to indicate acceptance of that legally binding text.

27. The method as set forth in claim 1, wherein at step 1k a manager either with no subordinates or all of whose subordinates, and their subordinates in turn, have completed their own reviews and have completed step 1j, can complete his/her own review by reading legally binding text reaffirming completion of his/her review, and providing an electronic signature, such as a validated password to indicate acceptance of that legally binding text.

28. The method as set forth in claim 1, wherein at step 1l completed reviews flow from the lowest level managers, one level of management at a time, up the organization tree, until at last all managers have completed the review process.
